(19) United States
(12) Patent Application Publication
(10) Pub. No.: US 2005/0157340 A1
(43) Pub. Date: Jul. 21, 2005

(54) Method for defining a job ticket in a pre-press workflow system

(75) Inventor: Peter Frings, Wilrijk (BE)

Correspondence Address: AGFA CORPORATION;LAW & PATENT DEPARTMENT, 200 BALLARDVALE STREET, WILMINGTON, MA, 01887, US

(73) Assignee: AGFA-GEVAERT, Mortsel (BE)

(21) Appl. No.: 10/505,462

(22) PCT Filed: Feb. 27, 2003
(86) PCT No.: PCT/EP03/50034

Related U.S. Application Data
(60) Provisional application No. 60/373,671, filed on Apr. 18, 2002.

(30) Foreign Application Priority Data
Feb. 28, 2002 (EP) 02100205.0

(51) Int. Cl. G06F 15/00

(52) U.S. Cl. 358/1.18

(57) ABSTRACT

A method for defining a job ticket in a pre-press workflow system. An input channel and a job ticket are defined. The job ticket definition includes the input channel definition.

### FIELD OF THE INVENTION

The invention relates to the field of pre-press workflow systems, and in particular to job tickets and input channels used in such systems.

### BACKGROUND OF THE INVENTION

In a pre-press workflow system, as disclosed e.g. in patent application WO 01/25907, jobs are processed, e.g. for commercial printing or for the packaging industry. In commercial printing, a job involves the processing of a specific set of document pages according to specified instructions. Most modern pre-press workflow systems are job ticket driven. Data processing activities are controlled by job tickets. A “job ticket” defines how a job is to be assembled and processed. It defines (for commercial printing) the pages that are to be assembled, it defines the processing features that are to be used (imposition, separation, trapping, overprinting, rasterization which is also called rendering, etc.), the output engine to which the rendered job will be sent. The job ticket editor allows the user to create and modify job tickets.

In prior art systems, an input mechanism needs to be associated with a job ticket. This input mechanism may contain so-called “input channels”; e.g. Agfa's Apogee™ Series 3 workflow software lets the user attach job tickets to input channels. Typical input channels can be TCP/IP streaming (TCP/IP stands for Transmission Control Protocol/Internet Protocol), Appletalk™, FTP (File Transfer Protocol), hot folders (a hot folder includes a location of a folder to which a file will be copied that is dropped in the hot folder), etc. When a document (content) is dropped in such an input channel, the document will be processed according to the specified job tickets.

There is still a need for an improved method for defining a job ticket in a pre-press workflow system.

### SUMMARY OF THE INVENTION

The present invention is a method for defining a job ticket in a pre-press workflow system as claimed in independent claim 1. The invention also includes a system and a computer program implementing the method. Preferred embodiments of the invention are set out in the dependent claims.

In a method in accordance with the invention, at least one input channel is defined and the definition of this at least one input channel is included within the job ticket. This is opposed to the prior art, wherein the input channel definition includes one or more job tickets.

An advantage of the invention is that multiple input channels can be defined within one job.

Another advantage is that input channels can easily be stopped when jobs are completed.

These advantages will be discussed more in detail below. Further advantages and embodiments of the present invention will become apparent from the following description and drawing.

### BRIEF DESCRIPTION OF THE DRAWINGS

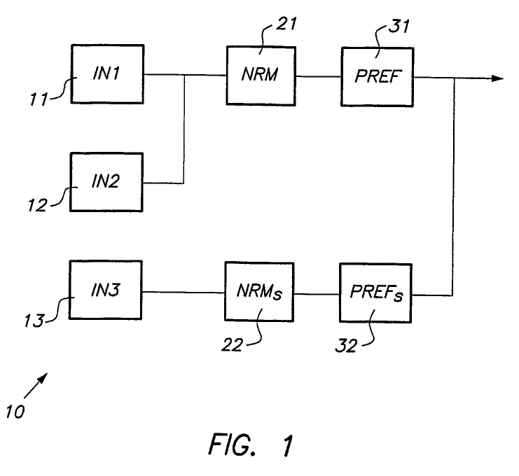

The invention is described with reference to FIG. 1 without the intention to limit the invention thereto; FIG. 1 diagrammatically shows an embodiment of a system in accordance with the invention.

### DETAILED DESCRIPTION OF THE INVENTION

FIG. 1 diagrammatically shows an embodiment of a job ticket 10 in accordance with the invention; the job ticket 10 includes three input channels 11-13. In fact, FIG. 1 represents a portion of a job ticket 10, namely a so-called “production plan”, and only the first part thereof. A production plan specifies how a job is to be processed; in FIG. 1, the data are processed according to the shown steps and in the direction of the arrow, i.e. from left to right. A job ticket 10 defines how a job is to be assembled and processed; a job ticket contains a production plan and additional data.

The embodiment shown in FIG. 1 includes three different input channels 11, 12 and 13. Input channel 11 is a hot folder “IN1”, input channel 12 is an Appletalk™ channel, “IN2”, and input channel 13 is another hot folder “IN3”. The definition of input channel 11 includes the location of the folder, on disk, to which files will be copied that are dropped in the hot folder (if e.g. a CD-ROM is delivered with files for the concerned job, all files on the CD-ROM will be copied to this folder, possibly after a check that they comply with specific conditions). The definition of input channel 11 further includes the expected file type, in this case either PS (PostScript™) or PDF (Portable Document Format™). Input channel 12 is defined as an Appletalk™ channel (i.e. for streaming input). It accepts files from a network of MacIntosh™ computers, that deliver data directly; the input channel 12 behaves for these computers analogously to a printer. Input channel 13 is defined as a hot folder accepting TIFF files (TIFF stands for Tag Image File Format).

This example illustrates that different settings may be defined for different input channels in a job. In the example, the file type has to be PS or PDF, for input channel 11, respectively TIFF, for input channel 13. This mechanism easily and clearly allows for checks, such as the check for a file type.

Different processing steps may also be defined for different input channels in a job. Referring again to FIG. 1, suppose that input channel 13 delivers input from another department within the company, and that this input has to be checked more strictly than the input from input channels 11 and 12. For these two input channels 11, 12 the usual normalizing step 21, “NRM”, and the usual preflighting step 31, “PREF” are applied, whereas for input channel 13 another, stricter normalizing step 22, “NRM_{S}” and another, stricter preflighting step 32, “PREF_{S}”, are used (a normalizer creates reliable PDF-files from the incoming files, while a preflight tool verifies critical elements, such as font embedding or image quality, of files).

An advantage of the invention is that input channels can easily be stopped when jobs are completed, or when the state of a job changes in some other way. Suppose e.g. that a particular job received all its documents; when the job reaches this state, the job may automatically stop its input channels. This is a protection against further, erroneous documents being input. If an input channel is stopped, it will no longer deliver input. Stopping a hot folder input channel may be implemented by still storing documents in the folder associated with the hot folder, but no longer processing them; stopping an input channel for streaming input may be implemented by removing the stream channel; preferably, the definitions of the input channels are preserved when they are stopped. In this way, stopped input channels can easily be reactivated.

Another advantage of the invention is that, preferably, all input channels of a job are deleted if a job is deleted; a separate clean-up operation of the input channels is thus not necessary.

It is preferred that an input channel only refers to a single job. When the job is submitted for execution, this allows to check for possible conflicts—e.g. a hot folder may not be in use by another job.

Yet another advantage of the invention is that input channels may be stored together with the job in the job ticket, which allows for better system consistency. In a preferred embodiment, by means of the job ticket editor the input mechanisms for the specified job are set up and the input channel definitions are stored within the job ticket. Job tickets may be stored in an extendable standard format like Adobe's PJTF (Portable Job Ticket Format) or the Job Definition Format, JDF, from CIP4.

Having described in detail preferred embodiments of the current invention, it will now be apparent to those skilled in the art that numerous modifications can be made therein without departing from the scope of the invention as defined in the appending claims.

### List of Reference Signs

10: job ticket
11: input channel
12: input channel
13: input channel
21: normalizer
22: normalizer
31: preflight tool
32: preflight tool

1. A method for defining a job ticket for a job in a pre-press workflow system, the method comprising the steps of:
defining an input channel for accepting at least one document by said pre-press workflow system and for performing a check of said at least one document; and
defining a job ticket for assembling said job from said at least one document and for processing said job by said pre-press workflow system;
wherein said job ticket definition comprises said input channel definition.

2. The method according to claim 1 further comprising the step of:
defining a second input channel; wherein said job ticket definition comprises said second input channel definition.

3. The method according to claim 2 further comprising the steps of:
defining a first setting for said input channel;
defining a second setting for said second input channel, wherein said second setting is different from said first setting.

4. The method according to claim 2 further comprising the steps of:
defining a first processing step for said input channel; and
defining a second processing step for said second input channel, wherein said second processing step is different from said first processing step.

5. The method according to claim 1 further comprising the steps of:
checking a state of said job; and
stopping said input channel if said state is a particular predetermined state.

6. The method according to claim 2 further comprising:
checking a state of said job; and
stopping said input channel if said state is a particular predetermined state.

7. A data processing system for defining a job ticket for a job in a pre-press workflow system, the data processing system comprising:
means for generating an input channel definition by defining an input channel for accepting at least one document by the pre-press workflow system and for performing a check of said at least one document; and
means for generating a job ticket definition by defining the job ticket for assembling the job from said at least one document and for processing the job by the pre-press workflow system;
wherein said job ticket definition comprises said input channel definition.

8. The system according to claim 7 further comprising an input device for inputting data for said job via said input channel.

9. A computer program product for defining a job ticket for a job in a pre-press workflow system, the computer program product comprising:
first program instructions for defining an input channel for accepting at least one document by said pre-press workflow system and for performing a check of said at least one document; and
second program instructions for defining a job ticket for assembling said job from said at least one document and for processing said job by said pre-press workflow system;
wherein said job ticket definition comprises said input channel definition.

10. (canceled)

11. The computer program product according to claim 9 further comprising a computer readable medium wherein said first and second program instructions are recorded on said medium.

12. The computer program product according to claim 9 further comprising third program instructions for defining a second input channel, wherein said job ticket definition comprises said second input channel definition.

13. The computer program product according to claim 12 further comprising:
fourth program instructions for defining a first setting for said input channel; and
fifth program instructions for defining a second setting for said second input channel, wherein said second setting is different from said first setting.

14. The computer program product according to claim 13 further comprising:
sixth program instructions for defining a first processing step for said input channel; and
seventh program instructions for defining a second processing step for said second input channel, wherein said second processing step is different from said first processing step.

15. The computer program product according to claim 14 further comprising:
eighth program instructions for checking a state of said job; and
ninth program instructions for stopping said input channel if said state is a particular predetermined state.
